(19) United States
(12) Patent Application Publication
(10) Pub. No.: US 2016/0043626 A1
(43) Pub. Date: Feb. 11, 2016

(54) POWER SUPPLY SOURCE FOR AN ELECTRIC HEATING SYSTEM

(71) Applicants: Vladimir Alekseevich KLYOSOV, Donetskaya obl. (UA); Sergey Nikolaevich ALEKSANDROV, Kharkov (UA)

(72) Inventors: VLADIMIR ALEKSEEVICH KLYOSOV, DONETSKAYA (UA); SERGEY NIKKOLAEVICH ALEKSANDROV, KHARKOV (UA)

(21) Appl. No.: 14/776,722

(22) PCT Filed: Mar. 17, 2014
(86) PCT No.: PCT/UA2014/000033

§ 371 Date: Sep. 14, 2015

(30) Foreign Application Priority Data
Mar. 18, 2013 (UA) A2013 03292

(51) Int. Cl. H02M 1/08; H05B 3/02

(52) U.S. Cl. CPC H02M 1/08; H05B 3/02; H02M 2001/0048

(57) ABSTRACT

The invention relates to power engineering, in particular to electric heating systems for residential and other buildings. The power supply source for an electric heating system comprises an inductance coil (1), which is connected to a load circuit (4) and is connected to a primary source (3) of electrical energy with the possibility of periodic connection of one of the ends of said coil (9) to one of the terminals of the primary source (3) of electrical energy via an electronic switch (6), and a generator (8) of unipolarity pulses, the output of which is connected to the input of the electronic switch (6). According to the invention, the second end (10) of the inductance coil (1) is connected to the second terminal of the primary source (3) of electrical energy via a second electronic switch (7), the input of which is connected to the output of said generator (8) of pulses of single polarity so as Co ensure synchronized operation of said electronic switches (6, 7). The result which can be achieved consists in increasing the energy conversion ratio.

### FIELD OF THE INVENTION

The present invention relates to power engineering, in particular electric systems for residential or other buildings.

### BACKGROUND OF THE INVENTION

In recent years the amount of electricity consciously converted into heat for domestic purposes (heating and/or hot water supplying) has considerably risen. The reason for this primarily is connected with obvious advantages of electric heating in comparison with generating of heat by direct fuel combustion. The processes of electric heating provide continuous functional abilities of equipment, stable heating parameters, a possibility of wide range of power controlling in the consumption place, as well as generality and simplicity of feeding energy carrier, high controllable heating processes and ecological purity of this process. The main component of an electric heating system is the power source expediency of using an electric heating system being determined by the electric energy conversion factor of the power source.

At present, in the field of electrical engineering and energy power engineering including electric heating systems, pulse power sources have found a wide use. For generating an output voltage a pulse power source utilizes the phenomenon of energy accumulation in inductance coils with following transfer of the stored energy to the consumer. An input pulse voltage is sent periodically to an inductance coil by means of a switch element. With each pulse, the pulse current which passes through the coil provides accumulation of the energy in the magnetic field of the coil. The energy accumulated in such a manner may be transferred into the load directly or through the secondary winding of a transformer. The known typical circuits of the pulse power sources differ only by the method of connecting the inductivity, while in the rest the principle of operation remains unchanged.

Such a scheme enables to increase considerably the energy conversion factor because it does not contain any power element dissipating the electric energy excluding the load itself. The switch transistors operate in a rich switch mode and dissipate an unimportant portion of power, only within rather short time intervals. Increasing the frequency of switching the switches makes it possible to augment substantially the power and improve the weight and size parameters of the device.

A typical peculiarity of the processes of energy accumulation in inductance coils with subsequent transfer of accumulated energy to the consumer is their interaction with environmental force fields. Now a lot of experimental facts have been accumulated for proving a real possibility of using the force fields (electric field, magnetic field, gravitational and other force fields) to obtain energy in the usual form, such as electric energy. Researches in this direction are carried out intensively in the U.S., Russia, Germany, Japan, and Switzerland. Herewith, calculations that are correctly made do not reveal any violation of the laws of thermodynamics; here just one form of energy is converted to another in accordance to the laws of physics.

Actually, various physical theories exist which confirm practical possibilities of obtaining energy by the way of converting force-field energy from the environment into the other forms of usual energy, as it is known e.g., from the references given below:
“Extracting Energy and Heat from the Vacuum”, Physical Review E, Volume of 48, p. 1562-1565, 1993;
Sakharov A. D., “Kvantovyie fluktuatsii vakuuma v iskrivlyonnom prostranstvie i teoriya gravitatsii”, Doklady Akademii Nauk SSSR, t. 12, 1968;
A. Frolov, “Svobodnaya energiya”, http://prometheus.al.ru/phisik/frolov.htm;
Kosinov N. V., Garbaruk V. I., Polakov D. V. “Energeticheskii fenomen vakuuma”, http://www.efir.com.ua/rus/

From the prior art it is known a plurality of technical solutions which allow to convert the environmental force-field potential energy into electric energy, and to realize various physical principles of energy conversion.

Thus, it is disclosed in U.S. Pat. No. 6,362,718 the electromagnetic generator which is operating without external power source. In accordance with such known technical solution, the generator after its start produces the energy for a long time after switching off the primary power source. The generator is an open dissipative system which accumulates the energy obtained from the environment, and converts it into electric energy. It is noted that this invention can not be considered as “perpetuum mobile” because the processes passing in it are consistent with the laws of conversion and conservation of energy.

WO/1999123749 describes method for autonomous power supply of electronic systems and device for carrying out this method by the way of conversion of energy from non-electric sources of environmental energy into electric energy by means of charge generators. Piezoelectric elements or triboelectric elements or radioactive charged particles sources may be used as charge generators, which unlike common electric power sources do not require periodical change or recharge.

There are also the other solutions that are served as examples of conversion of environmental force-field potential energy into usual electric energy. At first sight, results of such solutions are in contradiction with fundamental basis of modern physics. However, such solutions can not be considered as “perpetuum mobile” because processes passing in it are consistent with laws of conversion and conservation of energy. Intensive investigations are carried out on discovering the mechanisms of conversion of the environmental force-field potential energy into usual electric energy.

Despite plurality of known solutions, there is a problem of creation of alternative electric energy sources which realize in practice high-effective conversion of environmental force-field potential energy into electric energy.

In particular, it is known from the prior art an independent energetic device comprising an input circuit; two inductance coils inductively coupled with each other; means for forming electric pulses and sending them to a first inductance coil; a load circuit; means for transferring electric energy from a second inductance coil to the load circuit; means for stabilization of the electromagnetic field between the first and second inductance coils; a primary electric energy source; a self-feeding line of the device (WO/2008/103129).

The input circuit of that device comprises an input switch, and a capacitor which accumulates and transfers the electric energy from the primary source into the system. Means for forming and sending electric pulses to the first inductance coil includes serially connected with each other: a pulse unit, a high-frequency generator, a first filter and a first frequency controller. The pulse unit is connected to the input circuit, while the first filter is connected to the first inductance coil. The load circuit comprises a positive and a negative output cables, and a frequency converter which converts the electric energy obtained in the second coil into energy acceptable to the consumer. The means for transferring electric energy from the second inductance coil to the load circuit is provided by conductors which connect the ends of the second coil to the elements of the load circuit. The means for stabilization of the electromagnetic field between the first and second inductance coils includes the second filter and the second frequency controller. The primary electric energy source is connected to the input switch with possibility to ensure the possibility of its disconnection at the end of starting mode. The self-feeding line is provided by positive and negative cables which connect the load circuit to the input switch for ensuring the possibility of their connection to the input device after disconnection of the primary electric energy source.

When operating this device, electric energy is transferred from the primary source to the pulse unit, from the pulse unit to the high-frequency generator, from the high-frequency generator to the first inductance coil, to generate high-frequency electromagnetic field of the first inductance coil. Further, high-frequency electromagnetic field energy of the first inductance coil is transferred to the second inductance coil by means of inductive (transformer) coupling between the first and second inductance coils with conversion of the environmental force-field potential energy into the electric energy which is obtained in the second inductance coil.

The known device is described as a functional energetic module with a full energy conversion cycle and obtaining of energy at output. The description of this known device indicates that when it is necessary to increase the electric power, it is possible to create the energetic plants by the way of aggregation (increase of the number) of said modules to obtain desired electric power.

The device consumes energy of primary source only during the start period. This initial energy can be obtained from a low-power battery or battery pack, or from similar electric energy sources. In 1-2 seconds after starting of the device the primary source is disconnected. Further the device generates electric energy continuously without primary source. The device uses a small portion of the electric energy for self-feeding (auto-replenishment). The main portion of the electric energy is consumed by the user. Until the device is not disconnected or any fault does not occurred in it, the device generates energy continuously.

Common features for the known device and the claimed device are as follows:

A device for obtaining electric energy comprises an inductive system, an input circuit containing means for forming and sending electric pulses to the inductive system, a means for transferring electric energy from the inductive system to the load circuit, the primary electric energy source connected to the input circuit.

The known energetic plant described above represents one of some possible embodiments of technical means, which realizes conversion of environmental force-field energy into electric energy usual for the consumer, and possesses some advantages and disadvantages. Thus, a disadvantage of the described analogue is that a chain of energy transfer comprises a part which transfers the energy of electromagnetic field by means of inductive (transformer) coupling between two inductance coils. It is known that a transfer of the energy (energy of electromagnetic field) by such a way is inevitably associated with some irretrievable losses due to the hysteresis phenomena and absorption of energy by other (passive) objects, located in zone of action of the electromagnetic field, which decreases the efficiency of energy conversion. Coupling of inductance coil with a primary energy source via one of the ends of the coil limits a possible increase of the energy conversion factor. In addition to this presence of filters and frequency controllers complicates the structure and decreases the possibilities of its practical use.

The most relevant to the claimed invention is the power supply source described in (http://lib.qrz.ru/book/export/html/3842)

This known power supply source includes an inductance coil that is connected to a primary electric energy source (for instance, to accumulator or rectified voltage of electrical network) and connected to a load circuit transferring electric energy to the load (for instance, to TEHs—tubular electric heaters for an electric heating system of buildings). Connection of the inductance coil to the primary energy source is performed by connecting one of the ends of the inductance coil to one of terminals of the primary electric energy source via an electronic switch (usually, bipolar or MIS transistors) and by direct connecting the second end of the inductance coil to the second terminal of the primary electric energy source. The input of the electronic switch is connected to the output of a generator of unipolar pulses (generator of pulses of single polarity). Connection of the inductance coil to output voltage clamps (with load circuit) is provided by connecting one of the ends of the inductance coil to one of the output voltage clamps through an electronic valve (a diode) and by direct connecting of the second end of the inductance coil to the second output voltage clamp. For stabilization of output voltage the circuit diagram can comprise a feedback circuit, which varies the frequency or width of the unipolar pulses of the pulse generator depending on the values of output voltage. For accumulation of energy and smoothing the pulses of output voltage, a capacitor may be connected to the output clamps.

The known circuit diagram operates as described below.

By means of an electronic switch having the operating frequency of 20-100 kHz, the full voltage of the primary electric energy source periodically for a short time is supplied (delivered) to the inductance coil. At this time, delivering of electric energy from the primary source to the load circuit is blocked by the electronic valve with corresponding polarity of its connection in the circuit diagram. The pulse current passing through the inductance coil provides, as a result of known self-induction processes, energy accumulation in the magnetic field of the coil with each pulse. Accumulated energy of self-induction in the form of electric pulses is transferred from the inductance coil into the load through the open electronic valve when the electronic switch is closed. In such a manner, there is carried out a conversion of the electric energy from the primary source into the output electric energy of the pulse supply source. Transferring of electric energy from the inductance coil to the load may be realized directly or through the secondary winding of output transformer with subsequent rectification. Stabilization of output voltage may be performed by automatic control of width or frequency of the pulses on the electronic switch by means of feedback circuit.

The common features of the prototype and the claimed device are the following: a power source for electric heating system includes an inductance coil which is connected to a load circuit and connected to a primary electric energy source with possibility of periodical connection of one of its ends to one of terminals of the primary electric energy source via an electronic switch, a generator of unipolar pulses, the output of which is connected with the input of electronic switch.

As in the previously described prior art device in this case the communication of the inductance coil with the primary energy source is carried out through one of the ends of the inductance coil, which limits possibilities of increasing of energy conversion factor.

### SUMMARY OF THE INVENTION

The present invention is based on a main object of improving the supply source of electric heating system, in which owing to the use of a new proposed scheme an increase of the energy conversion factor is achieved.

This object is solved by the power supply source for electric heating system, which includes an inductance coil which is connected to a load circuit and connected to a primary electric energy source with possibility of periodical connection of one of its ends to one of the terminals of the primary electric energy source via an electronic switch, and a generator of unipolar pulses output of which is connected with the input of the electronic switch and in which according to the invention a second end of the inductance coil is connected to a second terminal of the primary electric energy source via a second electronic switch, input of which is connected with output of said generator of unipolar pulses while providing synchronic operation of said electronic switches.

It is preferable to perform the load circuit with electronic valves connected with possibility to block the electric energy transfer from the primary energy source to the load when electronic switches are open.

The claimed power source can comprise also a means for stabilization of output voltage in the form of a feedback circuit that couples the output of the supply source with the control input of the generator of unipolar pulses while ensuring the ability to vary the width or period of repetition of pulses, depending on the value of output voltage.

In addition in the other embodiment of the invention the power supply source can comprise means for self-feeding (auto-replenishment) of the system in the form of two valves which connect to each other the similar terminals of output voltage and the primary electric energy source.

The characteristic features of the invention (the second end of the inductance coil is connected to the second terminal of the primary electric energy source via the second electronic switch, input of which is connected to output of the generator of unipolar pulses while providing synchronic operation of said electronic switches) in combination with on features which is common with the prototype, provide achievement of the technical result—increase of the energy conversion factor.

The claimed power supply source is preferably used for electric heating systems for residential or other buildings, in which conversion of electric energy into heat energy is carried out by means of ohmic resistance of the load which, as a rule, uses TEHs, having the form of a metal tube with one or several high-ohmic spirals inside.

A typical feature of TEHs is independence of their work from the voltage form (sinusoidal, square or other pulses) and from frequency (not obligatory 50 Hz). Owing to this the claimed power supply source does not contains special electronic units, which (in known pulse power supply sources) are connected between the output of inductance coil and the load and provide complying the output signal with the requirements for an electric net, which is used for energy supplying electric motors, household technique, electronic devices, and other equipments by the way of conversion of output pulses of the inductance coil to a sinusoid with frequency of 50 Hz.

Hereinafter, the term “a load” is referred to the devices for conversing electric energy into heat energy by means of holmic resistance of the load among which the most preferred are tubular electric heaters—TEHs.

### BRIEF DESCRIPTION OF DRAWINGS

Below, the claimed power supply source for an electric heating system will be described in more detail with reference to the attached figures, in which:

FIG. 1 shows a circuit diagram of the power supply source for an electric heating system according to the invention.

FIG. 2—the same with valves introduced into a load circuit.

FIG. 3—the same with feedback circuit.

FIG. 4—the same with means for transferring energy from load circuit to input circuit.

FIG. 5 shows an oscillogram of pulses delivered to the inductance coil of the power sources of an electric heating under carrying out the experiment;

FIG. 6 shows an oscillogram of pulses at the output of a power supply source (at the load) with one electronic switch.

FIG. 7 shows an oscillogram of pulses at the output of the power supply source of the invention (at the load) with two electronic switches.

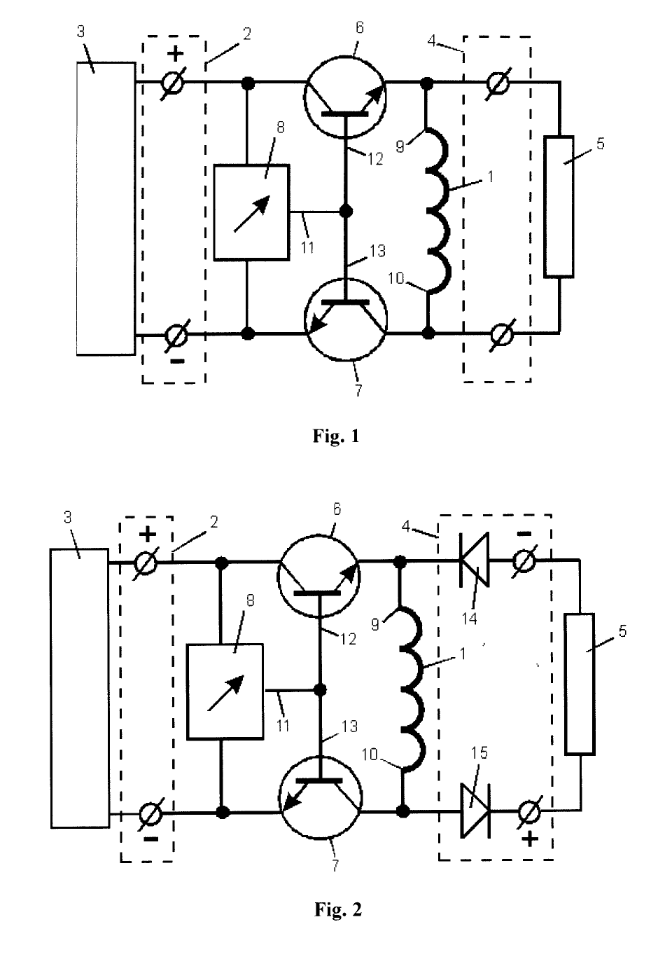

### THE BEST MODE FOR CARRYING OUT THE INVENTION

FIG. 1 shows the claimed power supply source for an electric heating system which includes an inductive coil 1, an input circuit 2 through which the inductive coil 1 is connected to an primary electric energy source 3, a load circuit 4 through which the inductive coil 1 is connected to a load 5, electronic switches 6, 7, and a generator 8 of unipolar pulses. Inductive coil 1 is connected to the primary electric energy source 3 by means of connection of its ends 9, 10 to opposite terminals (poles) of primary electric energy source 3 through electronic switches 6, 7 respectively. As an example, electronic switches 6, 7 here are shown as bipolar transistor switches which are the most preferred for the similar systems. However, electronic switches 6, 7 can be carried out as thyristors, electronic tubes or other electronic devices widely known to the persons skilled in the art. Output 11 of generator 8 of unipolar pulses is connected to inputs 12, 13 of electronic switches 6, 7 while providing synchronic operation (synchronic opening/closing) of electronic switches 6, 7.

The load circuit 4 can comprise electronic switches 14, 15 (diodes, transistors), through which the ends 9, 10 of inductive coil 1 are connected to the clamps of output voltage (Fig, 2). In this preferred embodiment of the invention transferring of energy from primary source 3 to the load 5 when switches 6, 7 is closed, is blocked, while transferring self-induction energy from inductive coil 1 to the load 5 is provided.

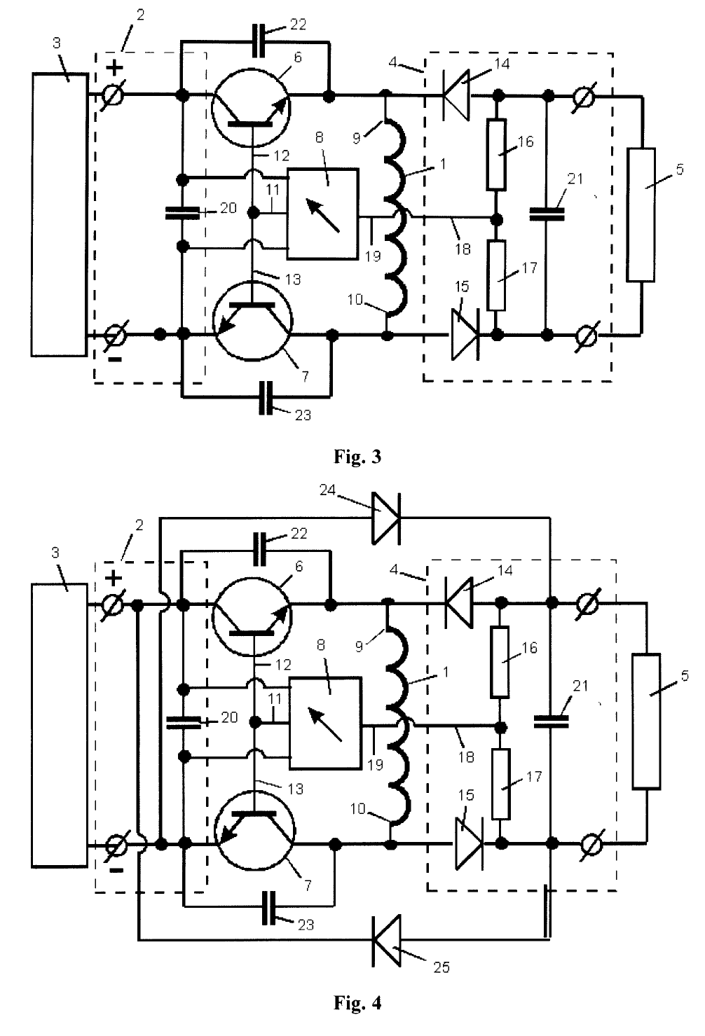

In the another preferred embodiment of the invention the claimed power supply source of the invention can comprise a means for stabilization of output voltage, for instance, in the form of a feedback circuit, which includes series resistors 16, 17 which are connected to the output clamps, and a line 18 which binds resistors 16, 17 with the control input 19 of generator 8 of unipolar pulses (FIG. 3). Capacitor 20 provides energy accumulation in the input circuit 3. Capacitor 21 provides energy accumulation in the load circuit 4 and smoothing output voltage. Capacitors 22, 23, connected in parallel to electronic switches 6,7 respectively, are used for protection of switches 6, 7 against electric sparks during the operations of opening/closing.

Besides, the claimed power supply source can comprise means for transferring a portion of output energy from the load circuit 4 to the input circuit 2 which provides the self-feeding mode of the system. This means can be carried out in the form of two valves 24, 25 which connect the terminals of output voltage and of the primary electric energy source 3 (FIG. 4).

The claimed power supply source for an electric heating system operates as described below.

Generator 8 generates periodical unipolar pulses having a width—tpulse, a pause—tpause with period of repetition T=tpulse+pause. The pulses are fed to the inputs 12, 13 of electronic switches 6, 7 with possibility to provide synchronic operation (synchronic opening/closing) of electronic switches 6, 7. By means of electronic switches 6, 7 having in operation a frequency of 5 Hz-100 MHz, a full voltage of the primary electric energy source 3 is delivered periodically to inductive coil 1. In this case transferring of electric energy of the primary source 3 into the load circuit 4 may be blocked by electronic valves 14, 15 at corresponding polarity of their switching-on. When electric current passes through inductive coil 1 under the open electronic switches 6, 7 an electromagnetic field around the coil 1 is formed with a predetermined energetic potential.

When switching off the electronic switches 6, 7, an electromotive force (emf) of self-induction in the coil 1 is induced (when the electric current through the coil 1 decreases the emf of self-induction arises and prevents decreasing of the electric current). The energy of the processes of self-induction in the form of electric pulses is transferred from the inductive coil 1 to the load 5 through the open electronic valves 14, 15 when electronic switches 6, 7 are closed.

In this manner a conversion of the electric energy of primary source 3 into the output electric energy of the pulse power source is realized.

Stabilization of output voltage may be provided by automatic regulation of the width tpulse or repetition period T of pulses by means of the feedback circuit (resistors 16, 17, line 18) which connects output of the power source with controlled input 19 of generator 8 of unipolar pulses.

The claimed power supply source may include means for transferring a portion of output energy from the load circuit 4 to the input circuit 2 to provide a self-feeding mode. A portion of output energy from the load circuit 4 is transferred to the input circuit 2 via two valves 24, 25, which connect similar terminals of the output voltage and the primary electric energy source 3.

The achievement of the technical result, i. e. increase of energy conversion factor when using the power source for electric heating system, has been confirmed by the following experiments.

The experiments were carried out with using two equivalents (supply sources for electric heating system) under conditions of equal electric energy consumptions of the experimental devices from the primary sources of electric energy while controlling the electric energy at the outputs of the devices.

Each of these devices contained similar: input circuit connected to their primary energy source; inductance coils; and output circuits connected to their load. Ends of inductance coils were connected directly to output circuit and indirectly to input circuit through the means of commutation of inductance coil with input circuit.

Difference between constructions of these devices was only in providing the means of communication of the coil with the input circuit.

In one of these devices, the means of communication was provided in the form of an electronic switch, through which one end of the coil was connected to one of the terminals of input circuit, while the second end of the coil was directly connected to the second terminal of input circuit. The controlled input of the electronic switch was connected to the generator of unipolar pulses to provide the periodic opening/closing of the electronic switch with the periodic connection/disconnection of one of the ends of the coil with one of the terminals of the input circuit.

In another device (the power supply source of claim 1 shown in FIG. 1), the means of commutation was carried out in the form of two electronic switches through which different ends of the inductance coil were connected to different terminals of the input coil. The controlled inputs of electronic switches were connected to the generator of unipolar pulses for providing the periodic, synchronous opening/closing of the electronic switches with periodic and synchronous connection/disconnection of the ends of the coil with corresponding terminals of the input circuit.

The conditions of the equal power consumptions of the devices, supplied with electric energy from the primary sources, were provided by equalities of the values of input voltage and input current for the both devices.

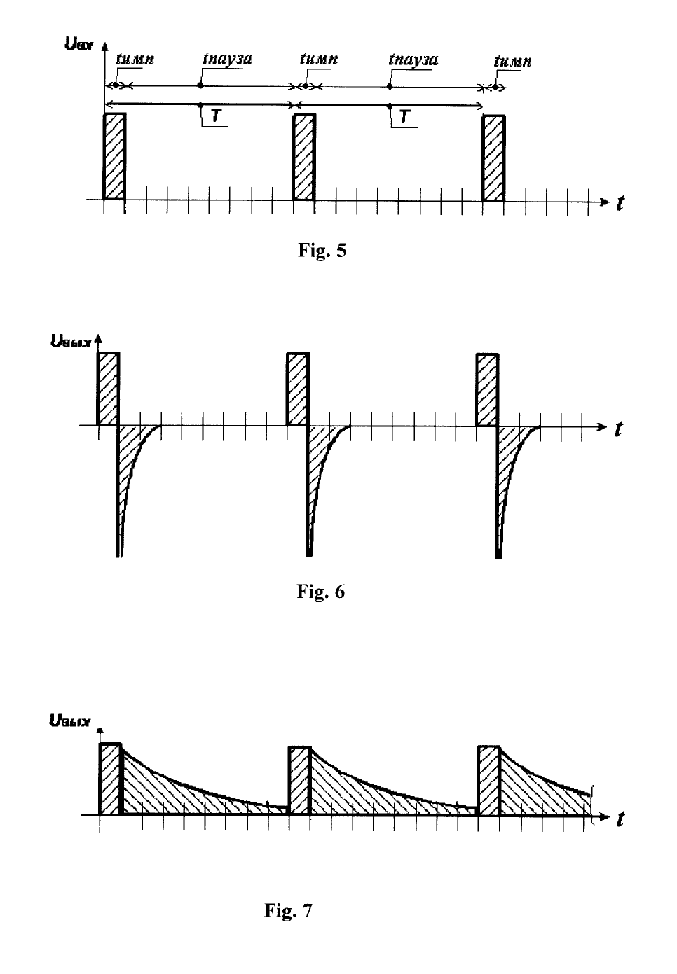

FIGS. 5-7 illustrate the forms of the obtained oscillograms. FIG. 5 shows the oscillogram of input pulses delivered to the coils via the electronic switches; duty ratio=1:9 (tpulse/T, where tpulse is the pulse duration, T is the pulse repetition period). FIG. 6 shows an oscillogram of output pulses of the device with one electronic switch. FIG. 7 shows an oscillogram of output pulses of the device with two electronic switches, Crosshatched areas are energetic characteristics of pulses. The more is the area, the more is the energy of the pulse. As can be seen from the oscillograms, the area of output pulses within the pause periods of operation of the device with two electronic switches is much more than the area of output pulses within the pause periods of operation of the device with one electronic switch.

Control of the electric energy at output of the devices was carried out by means of measuring the power of electric pulses at output of the devices within periods T of repetition of output pulses separately—within the pulse period tpulse or within the pause period tpause.

Results of the experiments are presented in the table below.

TABLE
Parameters of the experiments

| | | | | | | | | | |
|---|---|---|---|---|---|---|---|---|---|
| | | | | | | | | Pout | Pout |
| | | | | | | | | in period | in period |
| Uin | Ain | Rl | Rc | Lc | tPulse | T | tpulse/T | tpulse | tpause |

Values of parameters for the device with one electronic switch

| | | | | | | | | | |
|---|---|---|---|---|---|---|---|---|---|
| 600 | 60 | 10 | 28 | 180 | 10 | 90 | 1:9 | 36 | 0.04 |

Values of parameters for the device with two electronic switches

| | | | | | | | | | |
|---|---|---|---|---|---|---|---|---|---|
| 600 | 60 | 10 | 28 | 180 | 10 | 90 | 1:9 | 36 | 20.25 |

Where: Uin—input voltage, V; Ain—input current, A; RI—load resistance, Ohms; Rc—coil resistance, Ohms; Lc—coil inductance, rnH; tpulse—duration of input pulses. ps; T—repetition period of input pulses, ps; tpulse/T—duty ratio; Pout—power of output pulses, kW.

Thus, the powers of output pulses Pout within periods tpulse (duration of input pulses) in the experimental devices do not differ (36 kW). Within periods of pause of input pulses tpause the power of output pulses Pout in the experimental device with two electronic switches is higher than that of similar pulses in the experimental device with one electronic switch (respectively, 20.25 kW and 004 kW) at equal parameters of energy consumption of the experimental devices which obtain energy supply from the primary sources of energy (Uin=600 V, Ain=60 A—for each experimental device). In other words, the technical result—an increase of the energy conversion factor—is provided by that the power of output pulses in the experimental device with two electronic switches (which presents the claimed invention of claim 1), is much more than the power of similar pulses in the experimental device with one electronic switch.

1. A power supply source for an electric heating system comprising an inductance coil (1) which is connected to a load circuit (4) and connected to a primary electric energy source (3) with possibility of periodical connection of one of its ends (9, 10) to one of terminals of the primary electric energy source (3) via an electronic switch (6), and a generator (8) of unipolar pulses, output (11) of which is connected to the input of the electronic switch (6),
characterized in that
the second end (10) of the inductance coil (1) is connected to the second terminal of the primary electric energy source (3) via a second electronic switch (7), the input of which is connected with output (11) of said generator (8) of unipolar pulses while providing synchronic operation of said electronic switches (6, 7).

2. The power supply source according to claim 1, characterized in that the load circuit (4) comprises electronic valves (14, 15) connected with possibility to block the electric energy transfer from the primary electric energy source (3) to the load (5) when electronic switches (6, 7) are open.

3. The power source according to claim 1, characterized in that it comprises means for stabilization of output voltage in form of a feedback circuit connecting output of power supply source to a controlling input (19) of the generator (8) of unipolar pulses with possibility to vary the width or the pulse repetition period depending on the value of output voltage.

4. The power source according to claim 1, characterized in that it comprises means for self-feeding of the system in the form of two valves (24, 25) which are connected similar terminals of output voltage and the primary electric energy source (3).
